(19) United States
(12) Patent Application Publication
(10) Pub. No.: US 2014/0215041 A1
(43) Pub. Date: Jul. 31, 2014

(54) WORKLOAD MIGRATION DETERMINATION AT MULTIPLE COMPUTE HIERARCHY LEVELS

(71) Applicants: Eric K. Mann, Hillsboro, OR (US); Aviad Wertheimer, Jerusalem (IL)

(72) Inventors: Eric K. Mann, Hillsboro, OR (US); Aviad Wertheimer, Jerusalem (IL)

(21) Appl. No.: 13/995,214

(22) PCT Filed: Mar. 16, 2012
(86) PCT No.: PCT/US12/29317

§ 371 Date: Jun. 18, 2013

(51) Int. Cl. H04L 12/24

(52) U.S. Cl. CPC H04L 41/50
USPC 709/223

(57) ABSTRACT

An embodiment may include circuitry to determine at a first hierarchy level of a compute hierarchy, whether to consolidate, at least in part, respective workloads of respective compute entities at the first hierarchy level. The respective workloads may involve one or more respective processes of the respective compute entities. The circuitry may determine whether to consolidate, at least in part, the respective workloads based at least in part upon whether at least one migration condition involving at least one of the one or more respective processes is satisfied. After determining whether to consolidate, at least in part, the respective workloads, the circuitry may determine at a second hierarchy level of the compute hierarchy, whether to consolidate, at least in part, other respective workloads of other respective compute entities at the second hierarchy level. The second hierarchy level may be relatively lower in the compute hierarchy than the first hierarchy level.

### FIELD

This disclosure relates to workload migration determination at multiple compute hierarchy levels.

### BACKGROUND

In one conventional technique to improve network efficiency, servers in the network are examined, on a server-by-server basis, to determine whether any of the servers are under-utilized or over-utilized. If a particular server is determined to be under-utilized, its processes are migrated to another under-utilized server, and the particular server then is de-activated. Conversely, if a certain server is determined to be over-utilized, one or more of its processes are migrated to another server that is currently under-utilized. As can be appreciated, this conventional technique operates solely at a server-level of granularity, and involves significant implementation complexity and latency (e.g., to migrate all of the processes of entire servers, activate/de-active entire servers.

Another conventional technique involves using proxy services to execute autonomously while servers are otherwise de-activated to reduce power consumption. As can be appreciated, this conventional technique, like the previous one, does not contemplate or operate in a holistic or system-wide fashion, and/or across multiple levels of granularity in the network's computational hierarchy.

### BRIEF DESCRIPTION OF THE SEVERAL VIEWS OF THE DRAWINGS

Features and advantages of embodiments will become apparent as the following Detailed Description proceeds, and upon reference to the Drawings, wherein like numerals depict like parts, and in which:

FIG. 1 illustrates a system embodiment.

FIG. 2 illustrates features in an embodiment.

FIG. 3 illustrates features in an embodiment.

FIG. 4 illustrates features in an embodiment.

FIG. 5 illustrates features in an embodiment.

FIG. 6 illustrates features in an embodiment.

Although the following Detailed Description will proceed with reference being made to illustrative embodiments, many alternatives, modifications, and variations thereof will be apparent to those skilled in the art. Accordingly, it is intended that the claimed subject matter be viewed broadly.

### DETAILED DESCRIPTION

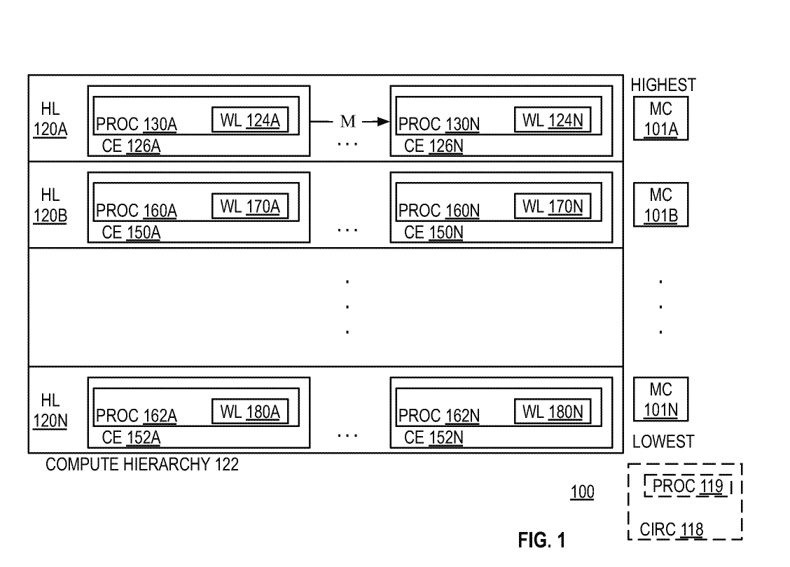

FIG. 1 illustrates a system embodiment 100. System 100 may include one or more compute hierarchies 122. Compute hierarchy 122 may include a plurality of compute hierarchy levels 120A . . . 120N. For example, the hierarchy levels 120A . . . 120N may comprise a highest hierarchy level 120A, one or more intermediate hierarchy levels (e.g., one or more levels 120B that may be relatively lower in the hierarchy 122 relative to the highest level 120A), and a lowest hierarchy level 120N. Each of these levels 120A . . . 120N may comprise one or more sets of one or more compute entities (CE). For example, each of the respective levels 120A . . . 120N may comprise at least one respective set of compute entities that may be at and/or associated with the respective level.

For example, at level 120A, the respective set of compute entities comprised in and/or associated with level 120A may be or comprise compute entities 126A . . . 126N. At level 120B, the respective set of compute entities comprised in and/or associated with level 120B may be or comprise compute entities 150A . . . 150N. At level 120N, the respective set of compute entities comprise in and/or associated with level 120N may be or comprise compute entities 152A . . . 152N.

In operation, each of the compute entities at each of the hierarchy levels may comprise, execute, and/or be associated with, at least in part, one or more respective processes and/or one or more respective workloads. These respective workloads may involve, result from, be carried out by, and/or be associated with the respective processes.

For example, respective compute entities 126A . . . 126N may execute respective processes 130A . . . 130N. Respective workloads 124A . . . 124N may involve, result from, be carried out by, and/or be associated with respective processes 130A . . . 130N.

Respective compute entities 150A . . . 150N may execute respective processes 160A . . . 160N. Respective workloads 170A . . . 170N may involve, result from, be carried out by, and/or be associated with respective processes 160A . . . 160N.

Respective compute entities 152A . . . 152N may execute respective processes 162A . . . 162N. Respective workloads 180A . . . 180N may involve, result from, be carried out by, and/or be associated with respective processes 162A . . . 162N.

In this embodiment, circuitry 118 may be external to, and/or distributed in, among, and/or he comprised in, at least in part, one or more of the compute entities (e.g., 126A . . . 126N, 150A . . . 150N, . . . 152A . . . 152N) at each of the hierarchy levels 120A . . . 120N. Circuitry 118 may execute, at least in part, one or more processes 119. The execution, at least in part, of one or more processes 119 by circuitry 118 may result, at least in part, in circuitry 118 determining, at least in part, at one or more hierarchy levels (e.g., the highest hierarchy level 120A) of the compute hierarchy whether to consolidate, at least in part, respective workloads (e.g., one or more workloads 124A and/or 124N) of respective compute entities (e.g., one or more compute entities 126A and/or 126N) at these one or more hierarchy levels 120A. Circuitry 118 may determine, at least in part, whether to consolidate, at least in part, these respective workloads 124A, 124N based at least in part upon whether at least one migration condition (e.g., one or more migration conditions 101A) involving, at least in part, at least one (e.g., one or more processes 130A) of one or more respective processes 130A . . . 130N of the respective compute entities 126A . . . 126N of the hierarchy level 120A is satisfied.

In this embodiment, after determining, at least in part, whether to consolidate, at least in part, these respective workloads 124A, 124N at hierarchy level 120A, the execution, at least in part, of one or more processes 119 by circuitry 118, may result, at least in part, in circuitry 118 determining, at least in part, at one or more other hierarchy levels (e.g., the next highest hierarchy level 120B relative to the highest hierarchy level 120A) whether to consolidate, at least in part, other respective workloads (e.g., one or more workloads 170A and/or 170N) of other respective compute entities (e.g., one or more compute entities 150A and/or 150N) at the hierarchy level 120B. This determination of whether to consolidate, at least in part, these other respective workloads 170A, 170N may be based, at least in part, upon whether at least one (e.g., one or more processes 160A) of one or more respective processes 160A . . . 160N of the respective compute entities 150A . . . 150N of the hierarchy level 120B is satisfied. As stated above, this second hierarchy level 120B may be relatively lower in the compute hierarchy 122 than the first hierarchy level 120A.

For example, in this embodiment, each of the respective hierarchy levels 120A . . . 120N, respective compute entities 126A . . . 126N, 150A . . . 150N, 152A . . . 152N, and/or processes 130A . . . 130N, 160A . . . 160N, 162A. . . . 162N executed by the respective compute entities at these respective levels may he associated with, at least in part, one or more respective migration conditions 101A . . . 101N. At each respective hierarchy level of the compute hierarchy 122, circuitry 118 may determine whether to consolidate and/or migrate, at least in part, respective workloads and/or processes at the respective hierarchy level based at least in part upon whether the one or more respective migration conditions 101A . . . 101N that may be associated, at least in part, with the respective hierarchy level, the respective compute entities at the respective hierarchy level, and/or the respective processes executed by the respective compute entities at the respective hierarchy level have been satisfied.

In this embodiment, a compute entity may be or comprise circuitry capable, at least in part, of being used, alone and/or in combination with one or more other entities, to perform, at least in part, one or more operations involved in, facilitating, implementing, related to, and/or comprised in one or more arithmetic, Boolean, logical, storage, networking, input/output (IO), and/or other computer-related operations. In this embodiment, a compute hierarchy level in a compute hierarchy may comprise one or more compute entities that are capable of being used, alone and/or in combination with one or more other compute entities, at least in part, to provide one or more inputs to and/or receive one or more outputs of one or more other compute hierarchy levels in the compute hierarchy. In this embodiment, if a compute hierarchy level comprises a plurality of compute entities, the compute entities may exhibit one or more similar and/or common virtual, logical, and/or physical characteristics functionalities, attributes, capabilities, and/or operations in the compute hierarchy that comprises the compute hierarchy. Also in this embodiment, a compute hierarchy may comprise a plurality of compute hierarchy levels.

Additionally, in this embodiment, a workload may comprise, be comprised in, relate to, involve, implicate, result in, and/or result from, at least in part, resource utilization implicated and/or resulting from, at least in part, execution and/or implementation, at least in part, of one or more processes and/or operations. For example, in this embodiment, a workload may comprise an amount of compute entity resources utilized and/or consumed by and/or as a result, at least in part, of execution of one or more processes executed by the compute entity. In this embodiment, a migration condition may comprise, involve, indicate, specify, result in, and/or result from, at least in part, at least one criterion that may be used and/or upon which may be based, at least in part, determination as to whether to migrate, at least in part. In this embodiment, migration may involve, for example, ceasing of active execution of a process by a compute entity and/or commencement of execution of the process by another compute entity (e.g., without loss of meaningful process state information by the other compute entity and/or meaningfully deleterious disruption of workload and/or process undergoing migration).

In this embodiment, the terms “host computer,” “host,” “server,” “client,” “network node,” and “node” may be used interchangeably, and may mean, for example, without limitation, one or more end stations, mobile interact devices, smart phones, media devices, I/O devices. tablet computers, appliances, intermediate stations, network interfaces, clients, servers, and/or portions thereof. In this embodiment, a network may be or comprise any mechanism. instrumentality, modality, and/or portion thereof that permits, facilitates, and/or allows, at least in part, two or more entities to be communicatively coupled together. In this embodiment, a subnet and/or subnetwork may be or comprise one or more portions of at least one network, such as, for example, a communication fabric that may be included or be used in one or more portions of an Internet Protocol (IP), Ethernet, proprietary (e.g., mesh), and/or other protocol network or subnet. Also in this embodiment, a first entity may be “communicatively coupled” to a second entity if the first entity is capable of transmitting to and/or receiving from the second entity one or more commands and/or data. In this embodiment, data and information may be used interchangeably, and may be or comprise one or more commands (for example one or more program instructions), and/or one or more such commands may be or comprise data and/or information. Also in this embodiment, an instruction may include data and/or one or more commands. In this embodiment, a packet may be or comprise one or more symbols and/or values. In this embodiment, a communication link may be or comprise any mechanism that is capable of and/or permits, at least in part, at least two entities to be or to become communicatively coupled.

In this embodiment, “circuitry” may comprise, for example, singly or in any combination, analog circuitry, digital circuitry, hardwired circuitry, programmable circuitry, co-processor circuitry, state machine circuitry, and/or memory that may comprise program instructions that may be executed by programmable circuitry. Also in this embodiment, a processor, host processor, central processing unit, processor core, core, and controller each may comprise respective circuitry capable of performing, at least in part, one or more arithmetic and/or logical operations, and/or of executing, at least in part, one or more instructions. In this embodiment, memory, cache, and cache memory each may comprise one or more of the following types of memories: semiconductor firmware memory, programmable memory, non-volatile memory, read only memory, electrically programmable memory, random access memory, flash memory, magnetic disk memory, optical disk memory, and/or other or later-developed computer-readable and/or writable memory.

In this embodiment, a portion or subset of an entity may comprise all or less than all of the entity. In this embodiment, a set may comprise one or more elements. Also, in this embodiment, a process, thread, daemon, program, driver, operating system, application, kernel, and/or virtual machine monitor each may (1) comprise, at least in part, and/or (2) result, at least in part, in and/or from, execution of one or more operations and/or program instructions.

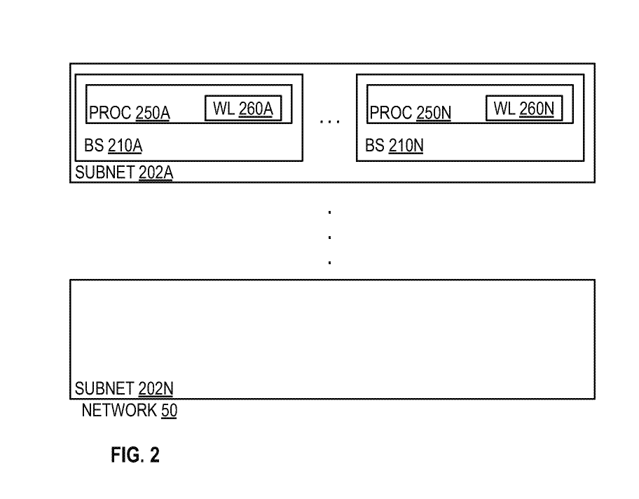

For example, with reference to FIGS. 1 and 2, the highest level 120A of compute hierarchy 122 may be, be comprised in, correspond to, or comprise, at least in part, at least one network subnet 202A that may be comprised in a network 50 that may comprise a plurality of such subnets 202A . . . 202N. Each of these subnets 202A . . . 202N may comprise a respective plurality of blade servers. For example, subnet 202A may comprise a plurality of blade servers 210A . . . 210N that may be, correspond to, be comprised in, or comprise, at least in part, compute entities 126A . . . 126N, respectively. The processes 250A . . . 250N and/or the workloads 260A . . . 260N may be, correspond to, be comprised in, or comprise, at least in part, processes 130A . . . 130N and/or workloads 124A . . . 124N, respectively.

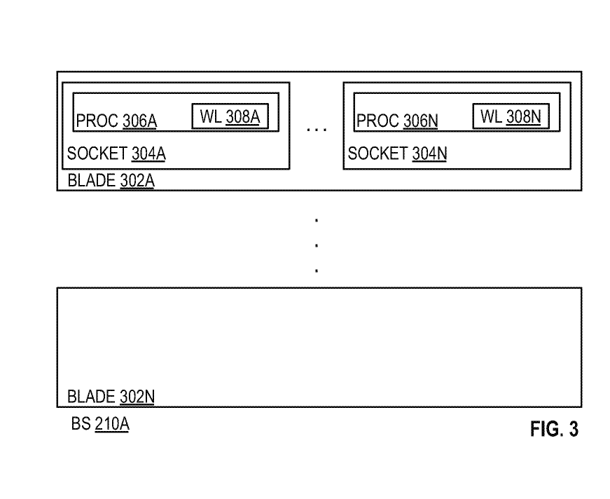

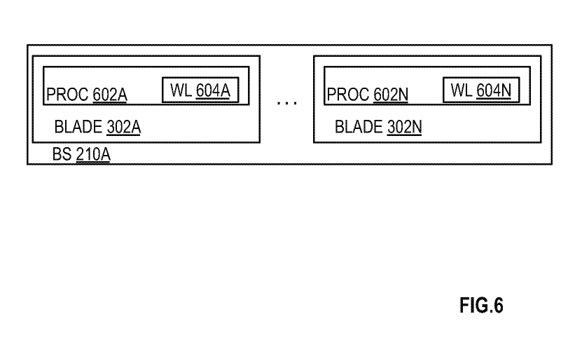

Analogously, the next highest level 120B of compute hierarchy 122 may be, be comprised in, correspond to, or comprise, at least in part, at least one blade server 210A that may be comprised, at least in part, subnet 202A. Blade server 210A may comprise a plurality of blades 302A . . . 302N (see FIG. 3). Each of these blades 302A . . . 302N may comprise a respective plurality CPU sockets. For example, blade 302A may comprise a plurality of CPU sockets 304A . . . 304N that may be, correspond to, be comprised in, of comprise, at least in part, compute entities 150A . . . 150N, respectively. The processes 306A . . . 306N and/or the workloads 308A . . . 308N may be, correspond to, be comprised in, or comprise, at least in part, processes 160A . . . 160N and/or workloads 170A . . . 170N, respectively. Analogously, blades 302A . . . 302N in blade server 210A may involve and/or be associated with, at least in part, one or more respective processes 602A . . . 602N that may involve and/or be associated with one or more respective workloads 604A . . . 604N (see FIG. 6).

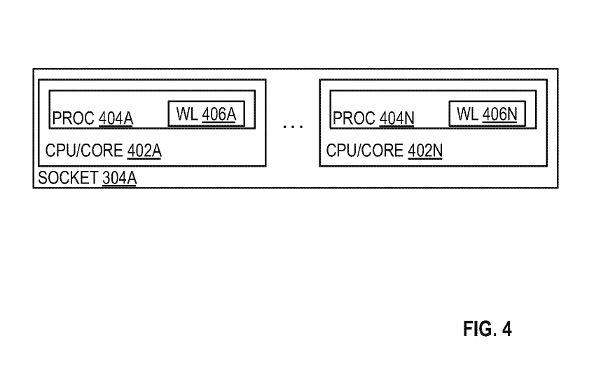

Also analogously, level 120N of compute hierarchy 122 may be, be comprised in, correspond to, or comprise, at least in part, at least one CPU socket 304A that may be comprised, at least in part, blade 302A. Socket 304A may comprise a plurality of CPU processors and/or processor cores 402A . . . 402N that may be, correspond to, be comprised in, or comprise, at least in part, compute entities 152A . . . 152N, respectively (see FIG. 4). The processes 404A . . . 404N and/or the workloads 406A . . . 406N may be, correspond to, be comprised in, or comprise, at least in part, processes 162A . . . 162N and/or workloads 180A . . . 180N, respectively.

In this embodiment, a blade server may be of comprise, at least in part, a server that may, but is not required to comprise at least one blade. In this embodiment, a blade may be or comprise at least one circuit board, such as, for example, a circuit board that is to be electrically and mechanically coupled to one or more other circuit boards via interconnect. In this embodiment, a CPU socket or socket may be of comprise, at least in part, one or more processors and/or central processing units and/or associated circuitry (e.g., I/O, cache, memory management, etc. circuitry).

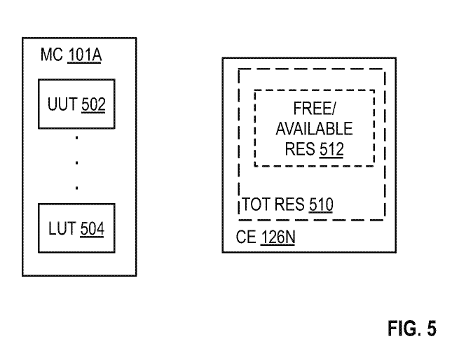

Turning now to FIG. 5, depending upon the particular implementation of system 100, one Of more migration conditions 101A may involve and/or comprise one or more upper resource utilization thresholds 502 and/or one or more lower resource utilization thresholds 504. During operation of system 100, circuitry 118 and/or one or more processes 119 may periodically monitor compute entities 126A . . . 126N, processes 130A . . . 130N, and/or workloads 124A . . . 124N to determine, at least in part, whether one or more conditions 101A are satisfied by processes 130A . . . 130N and/or workloads 124A . . . 124N. If so, depending upon the particular implementation of system 100 and/or which of the thresholds 502 and/or 504 are satisfied, circuitry 118 and/or one or more processes 119 may investigate whether one or more workload balancing migrations and/or one or more workload consolidation migrations may be appropriate.

Conditions 101A . . . 101N may be set, at least in part, via user input (e.g., via one or more not shown user interface systems) and or may be preset, at least in part. Alternatively or additionally, one or more of the conditions 101A . . . 101N may be dynamically determined according to one or more algorithms executed, at least in part, by circuitry 118 and/or one or more processes 119. In any case, migration conditions 101A . . . 101N may be selected and/or empirically determined to improve and/or promote processing efficiency of the hierarchy levels 120A . . . 120N. Although not shown in the Figures, migration conditions 101B . . . 101N may comprise upper and/or lower utilization thresholds analogous to those that may be comprised in one or more migration conditions 101A.

For example, upper utilization threshold 502 may indicate, at least in part, a maximum desired upper limit for resource utilization for individual compute entities 126A . . . 126N. For example, if the amount of resources of compute entity 126A that are consumed and/or utilized by one or more processes 130A and/or workload 124A is equal to or exceeds threshold 502, this may indicate that compute entity 126A is operating at a resource utilization level that does not promote optimal or desired levels of efficiency (e.g., optimal or desired heat generation, power consumption, and/or processing delays/latency, and/or minimum or desired total cost of ownership (TCO), etc.). Accordingly, if this occurs, circuitry 118 and/or one or more processes 119 may investigate whether it may be appropriate to perform a workload balancing migration (e.g., involving workload 124A and/or one or more processes 130A) from compute entity 126A to another compute entity in hierarchy level 120A (e.g., compute entity 126N) that may be operating below the upper utilization threshold, in order to permit both compute entities 126A and 126N to operate below the upper threshold 502 to thereby promote improved efficiency of compute entities 126A and 126N and hierarchy level 120A. In this embodiment, a resource of a compute entity may be or comprise one or more physical, virtual, and/or logical functions, operations, features, devices, and/or circuitry of the compute entity.

Conversely, lower utilization threshold 504 may indicate, at least in part, a minimum desired lower limit for resource utilization for individual compute entities 126A . . . 126N. For example, if the amount of resources of compute entity 126A that are consumed and/or utilized by one or more processes 130A and/or workload 124A is equal to or less than threshold 504, this may indicate that compute entity 126A is operating at a resource utilization level that does not promote optimal or desired levels of efficiency (e.g., optimal or desired heat generation, power consumption, and/or processing delay/latency, and/or minimum or desired TCO, etc.).

Accordingly, if this occurs, circuitry 118 and/or one or more processes 119 may investigate whether it may be appropriate to perform a workload consolidation migration (e.g., involving workload 124A and/or one or more processes 130A) from compute entity 126A to another compute entity in hierarchy level 120A (e.g.,, compute entity 126N) that may be operating below the upper utilization threshold, in order to promote improved efficiency of compute entities 126A and 126N and hierarchy level 120A by consolidating the two compute entities' workloads and/or processes for execution by a single compute entity (e.g., compute entity 126N). In this case, circuitry 118 may also be capable of taking action to lower power consumption of the compute entity that may be otherwise left idle following the migration/consolidation. Such action may involve, for example, powering-off (or otherwise placing into a relatively lower power consumption state/mode, e.g., relative to fully powered-up) the otherwise idle compute entity and/or one or more associated components (e.g., not shown system cooling circuitry electrical/power generators, and/or other components). Such system cooling circuitry may comprise, for example, at least certain air conditioning and/or fan circuitry. Potentially advantageously, this may further increase (and/or optimize) system and/or processing efficiency, and/or reduce TCO. For purposes of this embodiment, however, consolidation may be viewed broadly and may be usable in connection with workload/process balancing migration and/or consolidation migration.

In the above example, in the case of either a workload balancing migration or a workload consolidation migration, such migration may be appropriate if sufficient free resources are present in one or more of the compute entities (e.g., compute entity 126N) at level 120A to permit such migration. For example, if circuitry 118 and/or one or more processes 119 determine that the one or more migration conditions 101A are satisfied (e.g., by compute entity 126A operating at or above upper threshold 502, or at or below lower threshold 504, respectively), circuitry 118 and/or one or more processes 119 may determine, at least in part, whether one or more of the compute entities (e.g., compute entity 126N) at level 120A may have sufficient free resources to permit migration of the workload 124A and/or one or more processes 130A from compute entity 126A to that compute entity 126N. For example, as shown in FIG. 5, if the total amount 510 of resources of compute entity 126N includes an amount 512 of free resources that is at least sufficient to permit such migration, then circuitry 118 and/or one or more processes 119 may so determine and/or may initiate migration M of one or more workloads (e.g., workload 124A) and/or one or more processes (e.g., one or more processes 130A) of one or more compute entities (e.g., compute entity 126A) at hierarchy level 120A from these one or more compute entities 126A to the other one or more compute entities 126N. In the course and/or as a result, at least in part, of such migration M, the workload 124A and/or one or more processes 130A (together with any associated workload and/or process state information) may be transferred from compute entity 126A to compute entity 126N. After such migration M, the migrated workload 124A and/or the one or more migrated processes 130A may be associated with and/or executed by the compute entity 126N to which they were migrated, and they may no longer be associated with and/or executed by the compute entity 126A from which they were migrated.

In the case of a workload consolidation migration, after the migration M, the circuitry 118 and/or one or more processes 119 may power-off (e.g., deactivate and/or place into a relatively much lower power consumption level), at least in part, the compute entity 126A from which the workload 124 and/or one or more processes 130A were migrated. Potentially advantageously, this may further reduce power consumption and/or dissipation, and/or improve efficiency in system 100. Conversely, in the case of a workload balancing migration, after the migration M, compute entity 126A may remain powered-on (e.g., activated and/or fully operative) to permit execution of any remaining processes and/or workload of compute entity 126A.

Circuitry 118 and/or one or more processes 119 may periodically carry out analogous operations, for each of the compute entities at each of the hierarchy levels, to determine whether to initiate and/or perform respective workload consolidate migrations and/or respective workload balancing migrations for each such compute entity anchor at each such hierarchy level, based upon their respective migration conditions. For example, after carrying out analogous operations to those described above in connection with each of the compute entities at hierarchy level 120A, circuitry 118 and/or one or more processes 119 may carry out analogous operations (e.g., based upon one or more conditions 101B) for each of the compute entities at level 120B to determine whether to consolidate and/or balance other workloads and/or processes of the compute entities at level 120B. Thereafter, one or more subsequent iterations of such analogous operations may be carried out for the respective relatively lower levels (e.g., based upon their respectively associated migration conditions) in the hierarchy 122 until respective iterations of such operations have been carried out for all of the levels 120A . . . 120N. The above iterations then may re-commence at level 120A, and may periodically continue thereafter. Accordingly, circuitry 118 and/or one or more processes 119 may determine, at least in part, periodically, whether respective migration conditions 101A . . . 101N are satisfied for the respective compute entity sets at all respective hierarchy levels of the compute hierarchy 122.

Alternatively or additionally, for example, level 120A may correspond, at least in part, to the network 50, compute entities 126A . . . 126N may correspond, at least in part, to subnets 202A . . . 202N, level 120B may correspond, at least in part, to subnet 202A, and/or compute entities 150A . . . 150N may correspond, at least in part, to blade servers 210A . . . 210N. In this arrangement, after determining, at least in part, in accordance with the above techniques, whether to consolidate, at least in part, respective workloads of compute entities in levels 120A and 120B, circuitry 118 and/or one or more processes 119 may determine, at least in part, whether to consolidate, at least in part, respective blade workloads (e.g., 604A and 604N in FIG. 6) and/or processes (e.g., 602A and/or 602N) in blade server 210A. Thereafter, circuitry 118 and/or one or more processes 119 may determine, at least in part, whether to consolidate, at least in part, respective CPU socket workloads (e.g., 308A and 308N) and/or processes (e.g., 306A and 306N) in one or more blades (e.g., 302A) of blade server 302A (see FIG. 3). Thereafter, circuitry 118 and/or one or more processes 119 may determine, at least in part, whether to consolidate, at least in part, respective CPU core workloads (e.g., 406A and 406N) and/or processes (e.g., 404A and 404N) of socket 304A (see FIG. 4).

In this embodiment, machine-readable and executable program instructions may be stored, at least in part, in, for example, circuitry 118 and/or one or more of the compute entities in hierarchy 122. In operation of system 100, these instructions may be accessed and executed by, for example, circuitry 118 and/or these one or more compute entities. When so accessed and executed, these one or more machine-readable instructions may result in performance of the operations that are described herein as being performed in and/or by the components of system 100.

The IP subnet may be as defined in, in accordance with, and/or compatible with Internet Engineering Task Force (IETF) Request For Comments (RFC) 791 and/or 793, published September 1981. Of course, the respective numbers, types, constructions, operations, and/or configurations of the respective sets of compute entities comprised in the levels 120A . . . 120N may vary without departing from this embodiment.

Thus, an embodiment may include circuitry to determine at a first hierarchy level of a compute hierarchy, whether to consolidate, at least in part, respective workloads of respective compute entities at the first hierarchy level. The respective workloads may involve one or more respective processes of the respective compute entities. The circuitry may determine whether to consolidate, at least in part, the respective workloads based at least in part upon whether at least one migration condition involving at least one of the one or more respective processes is satisfied. After determining whether to consolidate, at least in part, the respective workloads, the circuitry may determine at a second hierarchy level of the compute hierarchy, whether to consolidate, at least in part, other respective workloads of other respective compute entities at the second hierarchy level. The second hierarchy level may be relatively lower in the compute hierarchy than the first hierarchy level.

Potentially advantageously, in this embodiment, multiple levels of granularity (e.g., corresponding, at least in part, to each of the hierarchy levels 120A . . . 120N and/or each of the compute entities comprised in these hierarchy levels 120A . . . 120N) may be employed when determining compute entity utilization, whether it is appropriate to migrate, and/or the entities from which and/or to which to migrate entity workloads and/or processes. Also potentially advantageously, after such migration has occurred, the entities from which such migration has occurred, may be powered-off or otherwise moved into relatively lower power consumption operation modes (e.g., depending upon the types of migration involved) in accordance with such granularity levels, etc. Also potentially advantageously, after such migration has occurred, associated components, such as system cooling circuitry may be powered-off or otherwise moved into relatively lower power consumption operation modes (e.g., relative to fully powered-up and/or operational modes), depending upon the types of migration involved and overall system heat dissipation. Accordingly (and potentially advantageously), this embodiment may operate in a holistic or system-wide fashion across multiple levels of granularity in the network's computational hierarchy, and with reduced implementation complexity and/or latency. Further potentially advantageously, this embodiment may offer compaction and/or consolidation of workloads and/or processes into fewer compute entities across multiple levels of the compute hierarchy granularity, thereby permitting improved fine-tuning of processing efficiency, reduction of power consumption, reduction of TCO, and/or reduction of heat dissipation to be provided. Yet further potentially advantageously, this embodiment may offer workload and/or process load balancing with improved granularity across multiple levels of the compute hierarchy, and therefore, for this reason as well, also may offer improved fine-tuning of processing efficiency, reduction of power consumption, reduction of TCO, and/or reduction of heat dissipation.

Many other and/or additional modifications, variations, and/or alternatives are possible without departing from this embodiment. For example, the particulars of the conditions 101A . . . 101N may vary at least between or among respective of the conditions 101A . . . 101N so as to permit the conditions 101A . . . 101N to be able improve and/or fine-tune processing and/or workload efficiency (and/or other efficiencies) between or among their respectively associated hierarchy levels 120A . . . 120N.

Additionally or alternatively, without departing from this embodiment, one or more of the hierarchy levels may comprise elements of for example, micro-server/micro-cluster architecture in which, instead of comprising blade servers and/or blades, the servers 210A . . . 210N and/or their blades may be or comprise individual micro-cluster/micro-server nodes, servers, and/or other elements. Additionally or alternatively, the blade servers and/or blades may comprise other types of nodes, server, and/or network elements. Additionally or alternatively, in this embodiment, the circuitry 118 may recursively (1) monitor the respective conditions at each of the hierarchy levels, and/or (2) determine, at each of the hierarchy levels, based at least in part upon the respective conditions, whether compute entity migration is warranted.

Other modifications are also possible. For example, the compute hierarchy and/or hierarchy levels therein comprise one or more other and/or additional hierarchies to those previously described. Such other and/or additional hierarchies may be or comprise, for example, one or more data centers that may comprise multiple server-containing entities, portions of such entities, and/or other entities (e.g., comprising multiple blade servers). Accordingly, this embodiment should be viewed broadly as encompassing all such alternatives, modifications, and variations.

What is claimed is:

1. An apparatus comprising:
circuitry to determine, at least in part, at a first hierarchy level of a compute hierarchy, whether to consolidate, at least in part, respective workloads of respective compute entities at the first hierarchy level, the respective workloads involving one or more respective processes of the respective compute entities, the circuitry to determine, at least in part, whether to consolidate, at least in part, the respective workloads based at least in part upon whether at least one migration condition involving at least one of the one or more respective processes is satisfied; and
after determining, at least in part, whether to consolidate, at least in part, the respective workloads at the first hierarchy level, the circuitry to determine, at least in part, at a second hierarchy level of the compute hierarchy, whether to consolidate, at least in part, other respective workloads of other respective compute entities at the second hierarchy level, the second hierarchy level being relatively lower in the compute hierarchy than the first hierarchy level.

2. The apparatus of claim 1, wherein:
the first hierarchy level comprises a network subnet;
the second hierarchy level comprises a server in the subnet;
after the circuitry determines,, at least in part, at the second hierarchy level, whether to consolidate, at least in part, the other respective workloads, the circuitry is also to determine, at least in part, whether to consolidate, at least in part, respective workloads within the server, and thereafter, whether to consolidate, at least in part, respective CPU socket workloads in the server.

3. The apparatus of claim 1, wherein:
if the circuitry determines to consolidate the respective workloads of respective compute entities at the first hierarchy level, the circuitry is to initiate migration of at least one of the respective workloads of at least one of the respective compute entities at the first hierarchy level to at least one other of the respective compute entities at the first hierarchy level, the migration comprising migrating the at least one of the one or more respective processes from the at least one of the respective compute entities at the first hierarchy level to the at least one other of the respective compute entities at the first hierarchy level.

4. The apparatus of claim 3, wherein:
after the migration and the migrating, the at least one of the respective compute entities at the first hierarchy level is to be placed into relatively lower power consumption operation mode relatively to fully powered-up mode, at least in part; and
the circuitry is to determine, at least in part, periodically whether respective migration conditions are satisfied for respective compute entity sets at all hierarchy levels of the compute hierarchy.

5. The apparatus of claim 1, wherein:
the at least one migration condition involves an upper utilization threshold and a lower utilization threshold;
at least one workload balancing migration is to be investigated if the upper utilization threshold is satisfied; and
at least one workload consolidation migration is to be investigated if the lower utilization threshold is satisfied.

6. The apparatus of claim 1, wherein:
if at least one migration condition is satisfied, the circuitry is to determine, at least in part, whether at least one of the respective compute entities at the first hierarchy level has sufficient free resources to permit workload migration.

7. A method comprising:
determining, at least in part, by circuitry, at a first hierarchy level of a compute hierarchy, whether to consolidate, at least in part, respective workloads of respective compute entities at the first hierarchy level, the respective workloads involving one or more respective processes of the respective compute entities, the circuitry to determine, at least in part, whether to consolidate, at least in part, the respective workloads based at least in part upon whether at least one migration condition involving at least one of the one or more respective processes is satisfied; and
after the determining, at least in part, also determining, at least in part, by the circuitry, at a second hierarchy level of the compute hierarchy, whether to consolidate, at least in part, other respective workloads of other respective compute entities at the second hierarchy level, the second hierarchy level being relatively lower in the compute hierarchy than the first hierarchy level.

8. The method of claim 7, wherein:
the first hierarchy level comprises a network subnet;
the second hierarchy level comprises a server in the subnet;
after the circuitry determines, at least in part, at the second hierarchy level, whether to consolidate, at least in part, the other respective workloads, the circuitry is also to determine, at least in part, whether to consolidate, at least in part, respective workloads within the server, and thereafter, whether to consolidate, at least in part, respective CPU socket workloads in the server.

9. The method of claim 7, wherein:
if the circuitry determines to consolidate the respective workloads of respective compute entities at the first hierarchy level, the circuitry is to initiate migration of at least one of the respective workloads of at least one of the respective compute entities at the first hierarchy level to at least one other of the respective compute entities at the first hierarchy level, the migration comprising migrating the at least one of the one or more respective processes from the at least one of the respective compute entities at the first hierarchy level to the at least one other of the respective compute entities at the first hierarchy level.

10. The method of claim 9, wherein:
after the migration and the migrating, the at least one of the respective compute entities at the first hierarchy level are to be powered down, at least in part; and
the circuitry is to determine, at least in part, periodically whether respective migration conditions are satisfied for respective compute entity sets at all hierarchy levels of the compute hierarchy.

11. The method of claim 7, wherein:
the at least one migration condition involves an upper utilization threshold and a lower utilization threshold;
at least one workload balancing migration is to be investigated if the upper utilization threshold is satisfied; and
at least one workload consolidation migration is to be investigated if the lower utilization threshold is satisfied.

12. The method of claim 7, wherein:
if at least one migration condition is satisfied, the circuitry is to determine, at least in part, whether at least one of the respective compute entities at the first hierarchy level has sufficient free resources to permit workload migration.

13. A computer-readable memory storing one or more instructions that when executed by a machine result in performance of operations comprising:
determining at least in part, by circuitry, at a first hierarchy level of a compute hierarchy, whether to consolidate, at least in part, respective workloads of respective compute entities at the first hierarchy level, the respective workloads involving one or more respective processes of the respective compute entities, the circuitry to determine, at least in part, whether to consolidate, at least in part, the respective workloads based at least in part upon whether at least one migration condition involving at least one of the one or more respective processes is satisfied; and
after the determining, at least in part, also determining, at least in part, by the circuitry, at a second hierarchy level of the compute hierarchy, whether to consolidate, at least in part, other respective workloads of other respective compute entities at the second hierarchy level, the second hierarchy level being relatively lower in the compute hierarchy than the first hierarchy

14. The memory of claim 13, wherein:
the first hierarchy level comprises a network subnet;
the second hierarchy level comprises a server in the subnet;
after the circuitry determines, at least in part, at the second hierarchy level, whether to consolidate, at least in part, the other respective workloads, the circuitry is also to determine, at least in part, whether to consolidate, at least in part, respective workloads within the server, and thereafter, whether to consolidate, at least in part, respective CPU socket workloads in the server.

15. The memory of claim 13, wherein:
if the circuitry determines to consolidate the respective workloads of respective compute entities at the first hierarchy level, the circuitry is to initiate migration of at least one of the respective workloads of at least one of the respective compute entities at the first hierarchy level to at least one other of the respective compute entities at the first hierarchy level, the migration comprising migrating the at least one of the one or more respective processes from the at least one of the respective compute entities at the first hierarchy level to the at least one other of the respective compute entities at the first hierarchy level.

16. The memory of claim 15, wherein:
after the migration and the migrating, the at least one of the respective compute entities at the first hierarchy level and an associated component are to be placed into a relatively lower power consumption operation mode relative to a fully powered-up mode, at least in part; and
the circuitry is to determine, at least in part, periodically whether respective migration conditions are satisfied for respective compute entity sets at all hierarchy levels of the compute hierarchy.

17. The memory of claim 13, wherein:
the at least one migration condition involves an upper utilization threshold and a lower utilization threshold;
at least one workload balancing migration is to be investigated if the upper utilization threshold is satisfied; and
at least one workload consolidation migration is to be investigated if the lower utilization threshold is satisfied.

18. The memory of claim 13, wherein:
if at least one migration condition is satisfied, the circuitry is to determine, at least in part, whether at least one of the respective compute entities at the first hierarchy level has sufficient free resources to permit workload migration.

19. The memory of claim 13, wherein:
the second hierarchy level comprises micro-cluster servers; and
the compute hierarchy comprises one or more additional hierarchy levels; and
the circuitry is to recursively:
monitor the respective conditions at each of the hierarchy levels; and
determine, at each of the hierarchy levels, based at least in part upon the respective conditions, whether compute entity migration is warranted.
